(19) United States
(12) Patent Application Publication
(10) Pub. No.: US 2022/0381342 A1
(43) Pub. Date: Dec. 1, 2022

(54) Gear Locking Mechanism

(71) Applicant: RAFAEL ADVANCED DEFENSE SYSTEMS LTD., Haifa (IL)

(72) Inventor: Dan MAGAZINNIK, Rakefet (IL)

(21) Appl. No.: 17/781,391

(22) PCT Filed: Dec. 21, 2020
(86) PCT No.: PCT/IB2020/062281

§ 371 Date: Jun. 1, 2022

(30) Foreign Application Priority Data
Feb. 19, 2020 (IL) 272778

(51) Int. Cl. F16H 63/34

(52) U.S. Cl. CPC F16H 63/3425; F16H 63/3466

(57) ABSTRACT

A gear locking mechanism includes a gear (or a sprocket wheel) having a series of substantially identical teeth and a locking tongue having a tooth (or teeth) configured in a locked position to engage the gear or sprocket wheel between any two of the series of substantially identical teeth of the gear or sprocket wheel. An anchoring structure restricts a degree of rotation of at least a portion of the locking tongue in the locked position. In the unlocked position, the restriction on the freedom of rotation is released. The locking tongue divided by a fixed pivot includes a movable distal portion of a see-saw having the tooth with the anchoring structure exerting a force against the proximal portion. Alternatively, the locking tongue rotates on a pin on a distal end and the anchoring structure urges a proximal portion toward the gear to lock.

### FIELD AND BACKGROUND OF THE INVENTION

The invention relates to apparatuses and methods for a gear locking mechanism for example for standard gears, and more particularly one that utilizes the existing gear in the design.

There are various ways known for locking a gear. Locking mechanisms (and servo systems) typically utilize a locking mechanism that combines with a specially designed tooth forming part of the gear. For example, in industry, there are various solutions that allow locking of transmissions with the assistance of gears that have special geometry. These solutions add additional volume, weight and cost to the transmissions or gears.

### SUMMARY OF THE EMBODIMENTS

One embodiment is a locking mechanism for locking gears or sprockets, comprising a gear or sprocket wheel having a series of substantially identical teeth; a locking tongue having a tooth, the tooth configured in a locked position to engage the gear or sprocket wheel in a groove between any two adjacent teeth of the series of substantially identical teeth of the gear or sprocket wheel; an anchoring structure configured to control a degree of rotation of at least a portion of the locking tongue, the portion containing the tooth, the anchoring structure deployed such that in a locked position of the locking mechanism there is a restriction on freedom of rotation of the at least the portion and in an unlocked position of the locking mechanism the restriction is released.

In some embodiments, the locking mechanism includes a spring biased to maintain the restriction on the at least the portion of the locking tongue and maintain the locking mechanism in the locked position as a default position.

In some embodiments, the locking tongue rotates on a pin that divides the locking tongue into a proximal portion connected to the anchoring structure and a distal portion that engages the gear, the tooth situated on the distal portion. In some embodiments, the anchoring structure exerts a force against the proximal portion of the locking tongue to hold it in the locked position of the locking mechanism. In some embodiments, the tooth is situated at a distal end of the distal portion.

In some embodiments, the anchoring structure holds a proximal portion of the locking tongue in the locked position of the locking mechanism.

In some embodiments, the tooth divides the locking tongue into a proximal portion connected to the anchoring structure and a distal portion that includes a pin that the locking tongue rotates on. In some embodiments, the anchoring structure acts on the proximal portion of the locking tongue to urge the proximal portion and the tooth toward the gear or sprocket wheel in the locked position. In some embodiments, the anchoring structure comprises a linear actuator configured to exert a force substantially perpendicular to the locked tongue in the locked position of the locking mechanism.

In some embodiments, the locking tongue is configured to engage the gear or sprocket wheel at a first portion of a circumference of a gear wheel or sprocket wheel different from a second portion of the circumference at which the gear wheel or sprocket wheel is configured to engage a second gear wheel or a chain.

In some embodiments, the locking tongue is configured to engage the gear at an extra thick portion of the gear or sprocket wheel. In some embodiments, the extra thick portion is at a same portion of a circumference of the gear wheel or sprocket wheel at which a second gear or chain engages the gear wheel or sprocket wheel. In some embodiments, the locking tongue has a second tooth that engages a second groove of the gear. In some embodiments, the locking mechanism further comprises a second locking tongue having a tooth configured in a locked position to engage the second gear in a groove between any two adjacent teeth of a series of substantially identical teeth of the second gear or of the chain.

In some embodiments, the locking tongue is engaged to the gear such that release of the restriction while the locking mechanism is under a load does not damage the gear or locking mechanism.

In some embodiments, a pivotal mounting of the locking tongue defines a pivot axis and a vector from the locking tooth toward the pivot axis makes an angle of between 14.5 and 25 degrees or between 15 and 25 degrees (for example 20 degrees) from a tangent to the gear or sprocket wheel.

In some embodiments, the locking tongue has at least one additional tooth, the at least one additional tooth configured in the locked position to engage the gear or sprocket wheel in at least one additional groove between any two or more adjacent teeth of the series of substantially identical teeth of the gear or sprocket wheel other than the tooth and wherein the at least the portion of the locking tongue contains the at least one additional tooth.

Another embodiment is a locking mechanism configured for locking and unlocking a gear, comprising a locking tongue having a tooth, the locking tongue configured in a locked position to engage a gear or sprocket wheel having a series of substantially identical teeth by the tooth engaging the gear or sprocket wheel in a groove between any two adjacent teeth of the series of substantially identical teeth of the gear or sprocket wheel, the gear or sprocket wheel external to the locking mechanism, a pivotal mounting of the locking tongue defining a pivot axis such that a vector from the locking tooth toward the pivot axis is substantially tangential to the gear or sprocket wheel; an anchoring structure configured to control a degree of rotation of at least a portion of the locking tongue, the portion containing the tooth, the anchoring structure deployed such that in a locked position of the locking mechanism there is a restriction on freedom of rotation of the at least the portion and in an unlocked position of the locking mechanism the restriction is released.

In some embodiments, the locking mechanism includes a spring biased to maintain the restriction on the at least the portion of the locking tongue and maintain the locking mechanism in the locked position as a default position.

In some embodiments, the locking tongue rotates on a pin that divides the locking tongue into a proximal portion connected to the anchoring structure and a distal portion that engages the gear, the tooth situated on the distal portion. In some embodiments, the anchoring structure exerts a force against the proximal portion of the locking tongue. In some embodiments, the tooth is situated at a distal end of the distal portion.

In some embodiments, the tooth divides the locking tongue into a proximal portion connected to the anchoring structure and a distal portion that includes a pin that the locking tongue rotates on. In some embodiments, the anchoring structure acts on the proximal portion of the locking tongue to urge the proximal portion and the tooth toward the gear or sprocket wheel in the locked position. In some embodiments, the anchoring structure comprises a linear actuator biased in the locked position substantially perpendicular to the locked tongue.

In some embodiments, the anchoring structure holds a proximal portion of the locking tongue in the locked position of the locking mechanism.

In some embodiments, the locking tongue has at least one additional tooth, the at least one additional tooth configured in the locked position to engage the gear or sprocket wheel in at least one additional groove between any two or more adjacent teeth of the series of substantially identical teeth of the gear or sprocket wheel other than the tooth and wherein the at least the portion of the locking tongue contains the at least one additional tooth.

These and other features, aspects and advantages of the invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a top view of two enmeshed gears with a locking tongue engaged to one of the gears in a see-saw configuration, in accordance with one embodiment;

FIG. 2 is a top view as in FIG. 1, with the locking mechanism unlocked, in accordance with an embodiment of the invention;

FIG. 3 is a top view of a locking mechanism in a pivot point configuration showing the locking tongue engaged with a gear in locked position, in accordance with one embodiment;

FIG. 4 is a view from the side and bottom of the locking mechanism of FIG. 3, in accordance with one embodiment;

FIG. 5A is a front view of the locking mechanism of FIG. 3 in locked position, in accordance with one embodiment;

FIG. 5B is a front view of the locking mechanism of FIG. 3 in unlocked position, in accordance with one embodiment;

FIG. 5C is an angled top view of the locking mechanism of FIG. 3 in unlocked position, in accordance with one embodiment;

FIG. 5D is a side view of the locking mechanism of FIG. 3 in unlocked position, in accordance with one embodiment;

FIG. 6 shows two graphs during operation of a servo actuator controlling operation of a locking mechanism, a top graph showing the current supplied to the servo actuator and a bottom graph showing the fine motion of the gear train responding to the servo actuator, in accordance with one embodiment; and

FIG. 7 is a schematic side view of a locking tongue having a tooth configured in a locked position to engage a sprocket wheel, in accordance with one embodiment.

### DETAILED DESCRIPTION OF THE EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain embodiments generally provide a standard locking mechanism that combines existing gears, servo actuators or sprocket and chain mechanisms into the design and locks them securely/positively. The existing gear or gears may be part of a transmission for a vehicle or any other device or system. There is no need for a specially designed gear having a specially designed tooth. The locking mechanism herein provides a reliable locking function without the need for a specially designed gear. One particular application of the locking mechanism is for it to be incorporated into aerodynamic platforms/mechanisms that are designed to spread aircraft wings.

Certain embodiments utilize a locking tongue configured to engage a gear and an anchoring structure that may comprise an actuating element, for example a linear actuator (for example a linear solenoid), that controls a degree of freedom of rotational motion of the locking tongue, or of a portion of the locking tongue. In certain embodiments, the default state of the gear(s) is that the gear(s) is normally locked. In the locked position, the locking tongue is not free to rotate and as a result neither is the gear. In some embodiments, upon an instruction from a controller to the solenoid or other actuator, the degree of rotational movement freedom of the locking tongue increases and the locking tongue is free to disengage from the gear. By toggling the anchoring element, the rotational degree of freedom of the tongue is enabled. The radial component of the contact force between the gear and the locking tongue causes the rotational motion which unlocks the system.

The fact that locking is possible with any of the teeth of the gear provides high resolution locking in certain embodiments, which is required for performance mapping (for example aerodynamic performance mapping) of various configurations and changing aerodynamic configurations during flight. It also allows one to specify the locking resolution. In one non-limiting example, if one wanted to lock a gear at every 5° rotation of the gear, the gear can be constructed with, for example, seventy-two teeth since the locking mechanism provides the ability to lock at any of the substantially identical adjacent teeth of the gear. In addition, release of the locking mechanism may be accomplished while under a load in certain embodiments. For example, the locking tongue may be engaged to the gear such that release of the restriction while the locking mechanism is under a load does not damage the gear or locking mechanism. In certain embodiments, release of the locking mechanism may be accomplished under a variety of loads and this may be implemented by controlling the geometry of the locking tongue, for example the length of the proximal portion of the locking tongue. In addition, since release of the lock is accomplished in certain embodiments by means of the moment of the servo motor, the lock is very robust and provides reduced risk of obsolescence and corrosion. Furthermore, in certain embodiments, there is provided an equally effective capability to lock the gear against either direction of the load.

By using a simple actuator and a locking mechanism that has only a small volume and/or a small amount of weight, certain embodiments of the invention provide a simple and inexpensive answer to the demand for an effective and cost-efficient locking mechanism for various applications.

The force on the locking tooth from the gear being locked is close to horizontal but not horizontal. Since the force is off from horizontal enough this allows the gear wheel to expel the tooth when the actuator is not locked and therefore the gear wheel can turn. Simultaneously, when the locking mechanism is locked and the locking tongue's freedom of rotation is restricted, the major component of the force is still horizontal so most of the force opposing the locking force of the gear wheel is supplied by the hinge, as opposed to the anchoring structure which typically includes a solenoid or other actuator. Therefore, a relatively small solenoid can be utilized.

The principles and operation of a Standard Gear Locking Mechanism may be better understood with reference to the drawings and the accompanying description.

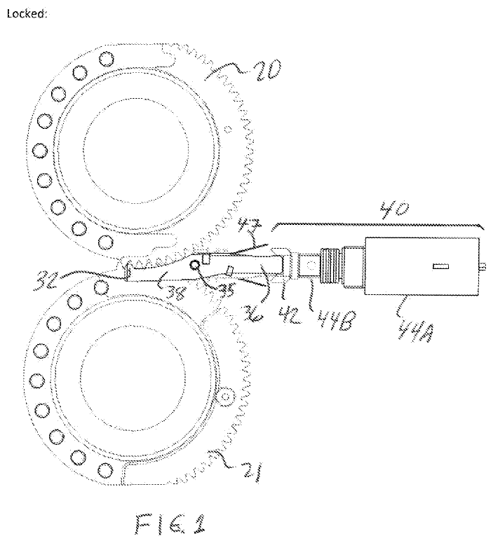

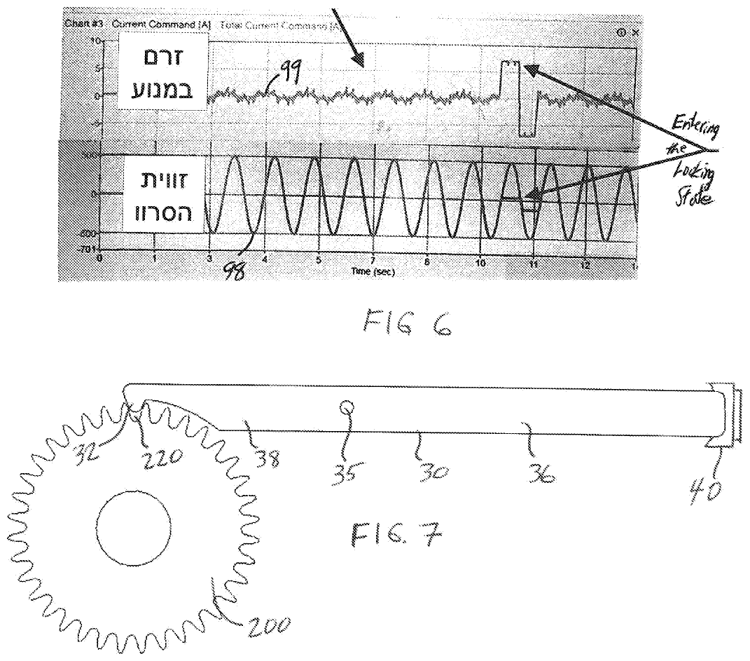

In embodiments shown in FIGS. 1-6, a locking mechanism 10 for locking gears or sprockets comprises a gear 20 having a series of substantially identical teeth 22. In a parallel embodiment shown in FIG. 7 for a sprocket instead of a gear, locking mechanism 10 comprises a sprocket wheel 200 having a series of substantially identical teeth 220.

Gear 20 need not be specially designed or designed differently to cooperate with locking tongue 30 of locking mechanism 10. Rather, gear 20, and any other gear (for example gear 21) that gear 20 engages with, may be structured in accordance with the requirements of the gear itself and of whatever mechanism the gear 20 is part of, for example the requirements for a vehicle transmission that gear 20 is part of.

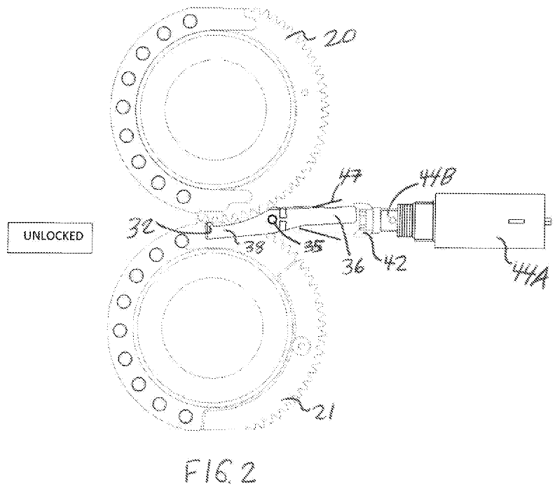

Locking mechanism 10 also comprises a locking tongue 30 having a tooth 32 or at least one tooth 32. Tooth 32 is configured in a locked position of locking mechanism 10 shown in FIG. 1. FIG. 1 depicts a configuration of locking tongue 30 that is sometimes referred to as the see-saw configuration of locked tongue 30 since locking tongue 30 rotates on a hinge 35 that divides locking tongue 30 into two parts. FIG. 2 shows the unlocked position.

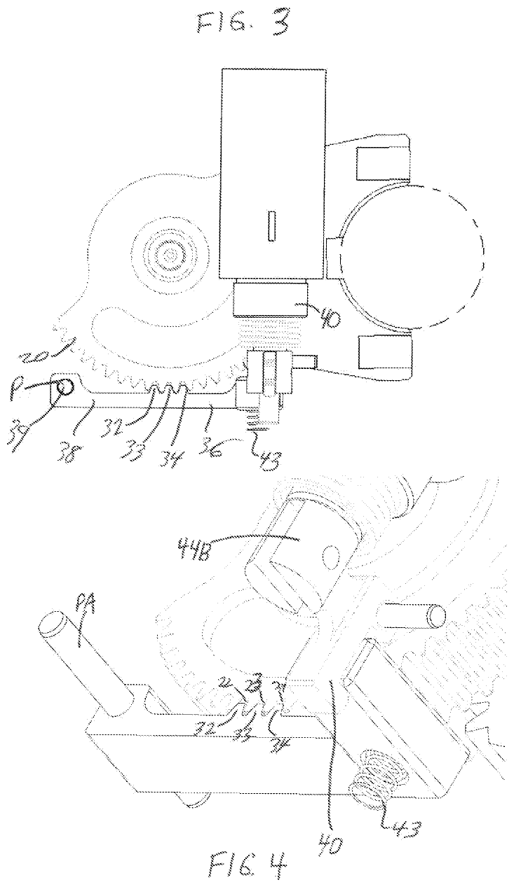

Locking mechanism 10 may also comprise a locking tongue having a configuration shown in FIG. 3 and sometimes referred to as the “pivot point” configuration. In either configuration, locking tongue 30 is configured to engage gear 20 (or sprocket wheel 200) between any two adjacent teeth of the series of substantially identical teeth 22 of gear 20 (or sprocket wheel 200) or more precisely engaging gear 20 (or sprocket wheel 200) in a groove between any two adjacent teeth 22 in the series of substantially identical teeth 22 of gear 20 (or sprocket wheel).

Locking tongue 30 has a distal portion 36 and a proximal portion 38 and these terms are defined relative to each portion's proximity to an anchoring structure 40. In the see-saw embodiment of FIG. 1 and FIG. 2, locking tongue 30 comprises a hinge 35, a distal portion 38 (distal to anchoring structure 40) on one side of hinge 35 and a proximal portion 36 on the other side of hinge 35 proximal to anchoring structure 40. In the pivot point embodiment shown in FIG. 3, the pivot point P may include a pin 39, for example a fixed pin 39 (or in some embodiments the pivot axis could be mobile), and locking tongue 30 comprises a distal portion 38 on one side of tooth 32 (or at least one tooth 32) and a proximal portion 36 on the other side of tooth 32 (or at least one tooth 32) proximal to anchoring structure 40.

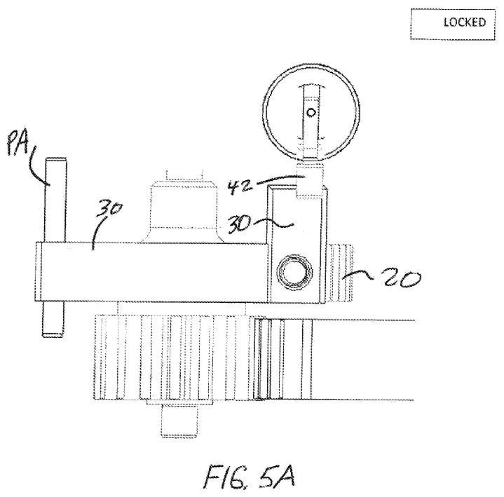

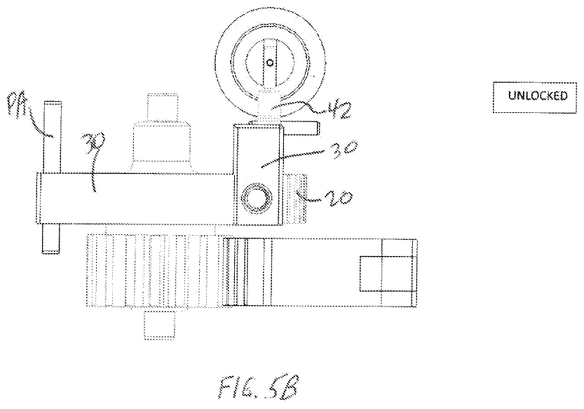

As seen from FIG. 4, FIG. 5A, FIG. B and FIG. 5C, locking tongue 30 is pivotally mounted so as to define a pivot axis PA. In locking mechanism 10, the pivot axis PA is such that a vector from locking tooth 30 toward pivot axis PA is at an angle of about 20 degrees to a tangent to gear 20 (or sprocket wheel) in certain embodiments.

In certain embodiments such as is shown in FIG. 3 and FIG. 4 (and which could also apply to the see-saw configuration of FIGS. 1-2), locking tongue 30 may have more than one tooth for example three teeth 32, 33, 34 (or in other embodiments not shown two teeth of four teeth or any other number of teeth). In that case, each of the three teeth 32, 33, 34 of locking tongue 30 is configured to engage gear 20 at a different groove between two adjacent teeth of gear 20. In the implementation shown in FIG. 3 and FIG. 4 these different grooves are consecutive grooves of gear 20. For example, a first tooth 32 is configured to engage gear 20 at a first groove 22 of gear 20 and a second tooth 33 is configured to engage gear 20 at a second groove 23 of gear 20 and a third tooth 33 is configured to engage gear 20 at a third groove 23 of gear 20, wherein grooves 22, 23, 24 happen to be consecutive grooves of gear 20. In general, locked tongue 30 may be configured as a tooth rack with as many teeth as is desired to correspond to grooves of gear 20.

In general, locking tongue 30 may have at least one additional tooth (33, 34 etc.), the at least one additional tooth (33, 34 etc.) configured in the locked position of locking mechanism 10 to engage the gear 20 or sprocket wheel 200 in at least one additional groove (23, 24, etc.) between any two or more adjacent teeth of the series of substantially identical teeth of the gear 20 or sprocket wheel 200 other than the tooth 32. In that case, the at least the portion of the locking tongue 30 (whose degree of rotation the anchoring structure 40 is configured to control) contains the at least one additional tooth (33, 34 etc.).

Locking mechanism 10 may also comprise an anchoring structure 40 configured to control a degree of rotation of at least a portion of the locking tongue 30, in particular the portion containing tooth 32. Anchoring structure 40 is deployed such that in a locked position of the locking mechanism 10 there is a restriction on freedom of rotation of the at least the portion of locking tongue 30 and in an unlocked position of the locking mechanism 10 the restriction is released. Anchoring structure 40 typically holds, in a locked position of locking mechanism 10, a portion of locking tongue 30 in order to accomplish this and this portion that is held is typically proximal to anchoring structure (i.e. a proximal portion 36 of locking tongue 30).

Anchoring structure 40 can be implemented in a number of ways. For example, anchoring structure 40 includes an anchoring element 42 that is the element that actually comes into contact with and holds proximal portion 36 of locking tongue 30 in the locked position of locking mechanism 10. Anchoring structure 40 may also include an actuator, a servomotor, an electromagnet or other structures that controls the anchoring element 42. For example, anchoring structure 40 may include an actuator, for example a linear actuator 44 such as a linear solenoid 44 including its body 44A and its plunger 44B. As shown in FIG. 1 and FIG. 2, where the locking tongue is configured as a see-saw 30, the linear solenoid 44, in a default mode that is the locked position of locking mechanism 10, holds the proximal portion 36 of locking tongue 30 for example by exerting a horizontal force (axially) against proximal portion 36 of locking tongue 30. This hold has the effect of restricting movement, including freedom of rotation, of the distal portion 38 of the seesaw configuration of locked tongue 30. For example, a plunger 42 of solenoid 40 holds the proximal end of proximal portion 36 of locking tongue 30 which restricts the freedom of rotation of distal portion 38 and of tooth 32.

The tooth 32 of locked tongue 30 is situated on the distal portion 38 (distal to the anchoring structure 40) so as to engage gear 20. In some embodiments, the tooth 32 is situated at a distal end 38a of the distal portion 38.

When a controller of linear solenoid 44 sends an instruction to stop exertion of a linear force against proximal portion 36 of locking tongue 30, for example when turning gear 20 is desired, freedom of rotation of the distal portion 38 of locking tongue 20 is restored. In some cases, tooth 32 may not immediately be ejected from groove 22 until gear 20 exerts a force on tooth 32 even though nothing prevents distal portion 38 from rotating any longer. However, once gear 20 turns, the force from gear 20, the force exerted on tooth 32 by gear 20 is enough to eject tooth 32 from groove 22 between the two substantially identical gear teeth of gear 20.

Release by anchoring structure 40 of locking mechanism 10 between locking tongue 30 and gear 20 may be accomplished under a variety of loads and in certain embodiments this may be done by controlling the length of the proximal portion 36 of locking tongue 30 (for example its length relative to the length of distal portion 38 of locking tongue 30). For example in FIG. 3 tooth 32 has a distance “x” to fixed pin 39 (as pivot point P of pivot axis PA) and proximal end 36a of distal portion 36 has a certain distance “y” to the same fixed pin 39 such that distance “y” is greater than distance “x”. Given a vector from the locking tooth 30 toward the pivot axis PA through pin 39, this vector makes an angle with a tangent to gear 20 of between 15° and 25° in some embodiments (or in other embodiments about 20° or between 17° and 23° or in other embodiments between 10′ and 30). Given a force exerted by anchoring structure 40 on locking tongue 30, since the moments at tooth 32 and at distal end 38a are the same, and since the distance from distal end 38a is greater than the distance from tooth 32 (to pivot point P at fixed pin 39), the force needed by spring 43 to be exerted upward at distal end 38a to urge locking tongue 30 to lock gear 20 is relatively small (i.e. smaller than the force needed to push tooth 32 into groove 23 of gear 20). Because this force is relatively small, solenoid 42 can have a relatively small volume and/or be relatively lightweight, thereby saving volume and/or weight and overall cost of locking mechanism 10. So by situating the distal end 38a such that the ratio of “y/x” of the respective distance is as great as possible, the volume and/weight and the cost of anchoring structure 40 can be minimized. Furthermore, when releasing the locking mechanism 10, the mechanical advantage can be used to implement the unlocking while gear 20 is under an external load.

Regarding the embodiment of locking tongue 30 shown in FIG. 1 and FIG. 2, the same is true. This is because in this embodiment also the force on the locking tooth 32 from the gear 20 is close to but not horizontal, and when the locking tongue 30 locks, the major component of the force opposing the locking force of the gear wheel 15 is supplied by the hinge 35 of the see-saw-shaped locking tongue 30, as opposed to the actuator 44 or solenoid 44.

In the “seesaw” embodiment shown in FIGS. 1-2, locking tongue 30 is configured to rotate on a pin 35, for example a fixed pin 35, or hinge 35 (or in some embodiments the pivot axis 35 could be mobile) that divides locking tongue 30 into a proximal portion 36 connected to anchoring structure 40 and a distal portion 38 (distal from anchoring structure 40) that engages gear 20. Tooth 32 is situated on distal portion 38, and typically at a distal end 38a of distal portion 38. In that configuration, anchoring structure 40 exerts a force against proximal portion 36 of locking tongue 30 preventing or restricting motion of proximal portion 36 and of locking tongue 30.

In the pivot point embodiment shown in FIG. 3 and FIG. 4, tooth 32 (or teeth 32, 33, 34) in effect divides locking tongue 30 into a proximal portion 36 proximally connected to anchoring structure 40 and the distal portion 38 that includes fixed pin 39 that locking tongue 30 rotates on. In that case, anchoring structure 40 acts on proximal portion 36 of locking tongue 30 to urge proximal portion 36 tooth 32 toward gear 20 (or sprocket wheel) in the locked position of locking mechanism 10. For example, anchoring structure 40 may comprise a linear actuator 44 configured to exert a force substantially perpendicular to locked tongue 30 in the locked position of the locking mechanism.

Locking mechanism 10 may include a spring 43 (FIG. 4) or a spring 47 (FIG. 3) biased to maintain the restriction on the at least the portion of the locking tongue 30 and maintain the locking mechanism 10 in the locked position as a default position. Spring 43 or 47 may also help push locked tongue 30 back into a locked position when it is desired to re-lock gear 20. Spring 47 may be a leaf spring.

In certain embodiments, locking tongue 30 is configured to engage gear 20 at an extra thick portion of gear 20 (or sprocket wheel 200). This allows gear 20 to simultaneously engage a second gear 21 while gear is engaged with tooth 32 of locking mechanism 30. For example, the extra thick portion may even be at a same portion of a circumference of the gear wheel (or sprocket wheel) at which second gear 21 (or chain) engages gear 20 (or sprocket wheel).

In a different implementation, locking tongue 30 is configured to engage the gear 20 (or sprocket wheel 200) at a first portion of a circumference of a gear (wheel) 20 (or sprocket wheel 200) different from a second portion of the circumference at which the gear 20 (or sprocket wheel) is configured to engage a second gear 21 (or a chain).

It is also possible to use two different locking tongues 30 to lock two different gears 20, 21 that are meshed with one another, although a single locking tongue locking a single gear 20 should be sufficient in most situations. For example, a second locking tongue 300 may have a tooth 320 configured in a locked position of a locking mechanism to engage gear 21 or sprocket wheel in a groove between any two adjacent teeth of the series of substantially identical teeth of the second gear 21 (or of the chain). The second locking tongue 300 would cooperate with the same or a different anchoring structure 40, for example so that both first gear 20 and second gear 21 are locked at the same time. Even if there are two different anchoring structures, they can have a single controller that shuts them on and off.

Release of locking mechanism 10 may be accomplished under a variety of loads and in certain embodiments this may be done by controlling the geometry of locking tongue 30. For example, in FIG. 1 and FIG. 2, the tail or proximal portion 36 of locking tongue 30 is roughly the same length as distal portion 38 (approximately a 1:1 ratio). However, by lengthening proximal portion 36 so that the ratio of the lengths of proximal portion 36 to distal portion 38 is for example 5:1, locking mechanism 10 would be able to handle a far greater load. Another way of being able to increase the load locking mechanism 10 is able to handle is by having locking mechanism 10 engage an earlier stage gear.

When locking mechanism 10 is in an unlocked position and the restriction of freedom of rotation of a portion of locking tongue 30 is released, this does not mean that tooth 32 automatically ceases to be meshed between two adjacent teeth of gear 20.

Reference herein to the fact that freedom of rotation is restricted means freedom of rotation is either eliminated entirely or a pre-determined amount of slack is allowed but not so much as to allow the tooth 32 (or teeth) to be ejected from the groove of gear 20 from the force of turning gear 20.

Freedom of rotation of the at least the portion is released means the freedom of at least a portion of locking tongue 30 to rotate is either completely unrestricted or it is restricted but in a manner that still allows gear 20 to turn.

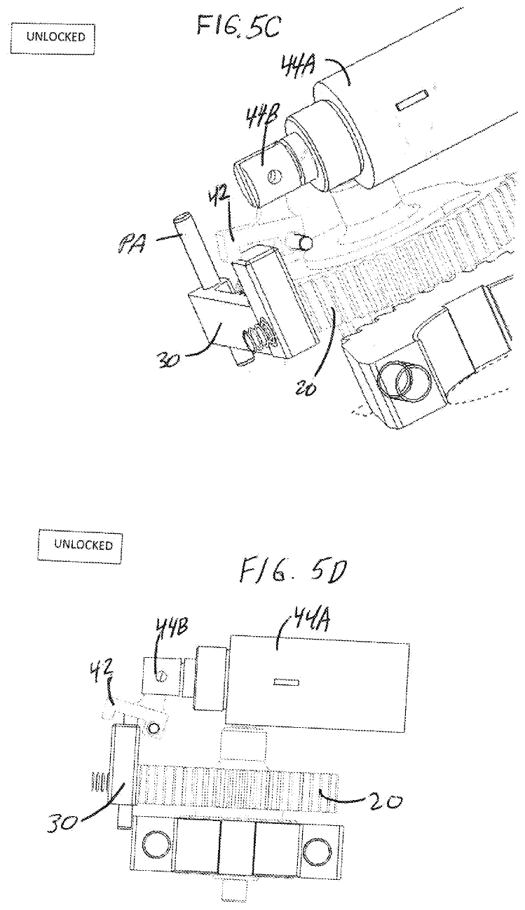

FIG. 6 shows two graphs during operation of a servo actuator controlling operation of a locking mechanism 10. In the top graph the current 99 is supplied to the servo actuator and in the bottom graph the fine motion 98 of the gear train is shown in response to the servo actuator. One can see from the bottom graph that during the period of the locked position of the locking mechanism (approximately t=10.5 to 11.1 seconds) there is no motion of the gear other than that caused by a backlash of the system and the elasticity of the gear train.

FIG. 7 shows a locking tongue 30 engaged to a sprocket wheel 200 (instead of to a gear). The principles described above regarding a locking mechanism 10 for a gear 20 apply as well to a locking mechanism 10 for a sprocket wheel 200. One technical difference is that instead of the sprocket wheel 200 engaging a second gear it would be expected to engage a chain (not shown).

A further embodiment of locking mechanism 10 defines the gear 20 as external to locking mechanism 10 as opposed to being part of locking mechanism 10. In that case, locking mechanism. 10 configured for locking and unlocking a gear (or a sprocket wheel), comprises a locking tongue 30 having a tooth 32 (or at least one tooth), wherein locking tongue 30 is configured in a locked position to engage a gear or sprocket wheel having a series of substantially identical teeth by the tooth engaging the gear or sprocket wheel in a groove between any two adjacent teeth of the series of substantially identical teeth of the gear or sprocket wheel, the gear or sprocket wheel external to locking mechanism 10.

Locking mechanism 10 includes an anchoring structure 40 configured to control a degree of rotation of at least a portion of the locking tongue, the portion containing the tooth 32, the anchoring structure 40 deployed such that in a locked position of the locking mechanism 10 there is a restriction on freedom of rotation of the at least the portion and in an unlocked position of the locking mechanism 10 the restriction is released.

A pivotal mounting of the locking tongue 30 defines a pivot axis such that a vector from the locking tooth 32 toward the pivot axis is at an angle of between approximately 15 and 25 degrees to a tangent line of the gear or sprocket wheel.

All variations of the locking tongue 30 and anchoring structure 40 of locking mechanism 10 discussed or described herein with respect to the embodiment of locking mechanism 10 that includes gear 20 (or sprocket wheel 200) apply equally well to this embodiment of locking mechanism 10 that excludes the gear (or sprocket wheel) in its definition.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A locking mechanism for locking gears or sprockets, comprising:
a gear or sprocket wheel having a series of substantially identical teeth;
a locking tongue having a tooth, the tooth configured in a locked position to engage the gear or sprocket wheel in a groove between any two adjacent teeth of the series of substantially identical teeth of the gear or sprocket wheel;
an anchoring structure configured to control a degree of rotation of at least a portion of the locking tongue, the portion containing the tooth, the anchoring structure deployed such that in a locked position of the locking mechanism there is a restriction on freedom of rotation of the at least the portion and in an unlocked position of the locking mechanism the restriction is released.

2. The locking mechanism of claim 1, wherein the locking mechanism includes a spring biased to maintain the restriction on the at least the portion of the locking tongue and maintain the locking mechanism in the locked position as a default position.

3. The locking mechanism of claim 1, wherein the locking tongue rotates on a pin that divides the locking tongue into a proximal portion connected to the anchoring structure and a distal portion that engages the gear, the tooth situated on the distal portion.

4. The locking mechanism of claim 3, wherein the anchoring structure exerts a force against the proximal portion of the locking tongue to hold it in the locked position of the locking mechanism.

5. The locking mechanism of claim 3, wherein the tooth is situated at a distal end of the distal portion.

6. The locking mechanism of claim 1, wherein the anchoring structure holds a proximal portion of the locking tongue in the locked position of the locking mechanism.

7. The locking mechanism of claim 1, wherein the tooth divides the locking tongue into a proximal portion connected to the anchoring structure and a distal portion that includes a pin that the locking tongue rotates on.

8. The locking mechanism of claim 7, wherein the anchoring structure acts on the proximal portion of the locking tongue to urge the proximal portion and the tooth toward the gear or sprocket wheel in the locked position.

9. The locking portion of claim 7, wherein the anchoring structure comprises a linear actuator configured to exert a force substantially perpendicular to the locked tongue in the locked position of the locking mechanism.

10. The locking mechanism of claim 1, wherein the locking tongue is configured to engage the gear or sprocket wheel at a first portion of a circumference of a gear wheel or sprocket wheel different from a second portion of the circumference at which the gear wheel or sprocket wheel is configured to engage a second gear wheel or a chain.

11. The locking mechanism of claim 1, wherein the locking tongue is configured to engage the gear at an extra thick portion of the gear or sprocket wheel.

12. The locking mechanism of claim 11, wherein the extra thick portion is at a same portion of a circumference of the gear wheel or sprocket wheel at which a second gear or chain engages the gear wheel or sprocket wheel.

13. The locking mechanism of claim 12, wherein the locking tongue has a second tooth that engages a second groove of the gear.

14. The locking mechanism of claim 12, further comprising a second locking tongue having a tooth configured in a locked position to engage the second gear in a groove between any two adjacent teeth of a series of substantially identical teeth of the second gear or of the chain.

15. The locking mechanism of claim 1, wherein the locking tongue is engaged to the gear such that release of the restriction while the locking mechanism is under a load does not damage the gear or locking mechanism.

16. The locking mechanism of claim 1, wherein a pivotal mounting of the locking tongue defines a pivot axis and a vector from the locking tooth toward the pivot axis makes an angle of between 15 and 25 degrees from a tangent to the gear or sprocket wheel.

17. The locking mechanism of claim 1, wherein the locking tongue has at least one additional tooth, the at least one additional tooth configured in the locked position to engage the gear or sprocket wheel in at least one additional groove between any two or more adjacent teeth of the series of substantially identical teeth of the gear or sprocket wheel other than the tooth and wherein the at least the portion of the locking tongue contains the at least one additional tooth.

18. A locking mechanism configured for locking and unlocking a gear, comprising:
a locking tongue having a tooth, the locking tongue configured in a locked position to engage a gear or sprocket wheel having a series of substantially identical teeth by the tooth engaging the gear or sprocket wheel in a groove between any two adjacent teeth of the series of substantially identical teeth of the gear or sprocket wheel, the gear or sprocket wheel external to the locking mechanism, a pivotal mounting of the locking tongue defining a pivot axis such that a vector from the locking tooth toward the pivot axis is substantially tangential to the gear or sprocket wheel;
an anchoring structure configured to control a degree of rotation of at least a portion of the locking tongue, the portion containing the tooth, the anchoring structure deployed such that in a locked position of the locking mechanism there is a restriction on freedom of rotation of the at least the portion and in an unlocked position of the locking mechanism the restriction is released.

19. The locking mechanism of claim 18, wherein the locking mechanism includes a spring biased to maintain the restriction on the at least the portion of the locking tongue and maintain the locking mechanism in the locked position as a default position.

20. The locking mechanism of claim 18, wherein the locking tongue rotates on a pin that divides the locking tongue into a proximal portion connected to the anchoring structure and a distal portion that engages the gear, the tooth situated on the distal portion.

21. The locking mechanism of claim 20, wherein the anchoring structure exerts a force against the proximal portion of the locking tongue.

22. The locking mechanism of claim 20, wherein the tooth is situated at a distal end of the distal portion.

23. The locking mechanism of claim 18, wherein the tooth divides the locking tongue into a proximal portion connected to the anchoring structure and a distal portion that includes a pin that the locking tongue rotates on.

24. The locking mechanism of claim 23, wherein the anchoring structure acts on the proximal portion of the locking tongue to urge the proximal portion and the tooth toward the gear or sprocket wheel in the locked position.

25. The locking portion of claim 23, wherein the anchoring structure comprises a linear actuator biased in the locked position substantially perpendicular to the locked tongue.

26. The locking mechanism of claim 18, wherein the anchoring structure holds a proximal portion of the locking tongue in the locked position of the locking mechanism.

27. The locking mechanism of claim 18, wherein the locking tongue has at least one additional tooth, the at least one additional tooth configured in the locked position to engage the gear or sprocket wheel in at least one additional groove between any two or more adjacent teeth of the series of substantially identical teeth of the gear or sprocket wheel other than the tooth and wherein the at least the portion of the locking tongue contains the at least one additional tooth.
